(19) United States
(12) Patent Application Publication
(10) Pub. No.: US 2011/0083518 A1
(43) Pub. Date: Apr. 14, 2011

(54) Correlating Push Force and Stalk Vibration to a Plant's Susceptibility to Root Lodging, Stalk/Stem Lodging and Brittle Snap (Broken Stems or Stalks)

(75) Inventors: Roberto Barreiro, Honolulu, HI (US); Christopher L. Baszcynski, Earlham, IA (US); Terry EuClaire Meyer, Urbandale, IA (US)

(73) Assignee: Pioneer Hi-Bred International, Inc., Johnston, IA (US)

(21) Appl. No.: 12/577,368

(22) Filed: Oct. 12, 2009

(51) Int. Cl. G01L 1/10

(52) U.S. Cl. 73/862.59

(57) ABSTRACT

The present device enables measurement of the susceptibility of plants to root lodging, stalk or stem lodging and brittle snap (broken stems or stalks). The device is used to push on a plant stalk or stem and the force used to push over the stalk/stem, and the vibration of the stalk/stem caused by the push are recorded. As material breaks in the stalk/stem, an accelerometer, measures stalk/stem vibration response to the breaking events; the data is then recorded to allow quantitative measurements of the susceptibility of plants to root lodging, stalk or stem lodging and brittle snap (broken stems or stalks). This allows meaningful comparisons of various hybrids or varieties at early stages of evaluation and advancement.

### FIELD OF THE INVENTION

This invention relates to a method and device for measuring the susceptibility of Helianthus annuus, commonly called sunflower or mirasol; Brassica, also known as rape, oilseed rape, rapa, rapaseed and canola; and sorghum plants to root lodging, stalk or stem lodging and brittle snap (broken stems or stalks). The invention provides a way of measuring and recording root lodging, stalk or stem lodging and brittle snap (broken stems or stalks) so the data can be specifically used to provide meaningful information in hybrid or variety breeding to facilitate the development of sunflower, canola and sorghum plants having good root lodging, stalk or stem lodging and brittle snap (broken stems or stalks) properties.

### BACKGROUND OF THE INVENTION

The advent of biofuel production has resulted in a decrease in the acreage available for human food and animal feed crop production. Increasingly in order to feed the world's human and livestock populations, it is becoming more important that crops produce higher yields on less acres. One way to do this is to provide heartier crop plants that withstand the environmental forces causing root lodging, stalk or stem lodging, and brittle snap (broken stems or stalks). This is particularly important in crops such as sunflower, canola, and sorghum. Growers thus are interested in producing plants that have the very best grain or plant quality properties, produce the highest yield and therefore have the greatest potential for income.

Cultivated sunflower (Helianthus annuus L.) is an increasingly important oilseed crop in many temperate, semi-dry regions of the world. The cultivated sunflower is a major source of vegetable oil worldwide. Oil types of sunflowers contain 40 to 48 percent or more oil in the seed. Sunflower oil is valued as an edible oil because of its high unsaturated fat level and light color. Sunflower oil is used for salads, cooking oil or margarine. The protein content of sunflower meal prepared from seeds after oil extraction is useful as livestock feed. In addition, the seeds from both oil and confectionery varieties of cultivated sunflower are useful as bird food.

Oilseed from Brassica plants is also an increasingly important crop. As a source of vegetable oil, it presently ranks behind only soybeans and palm in commercial market volume. The oil is used for many purposes such as salad oil and cooking oil. Upon extraction of the oil, the meal is used as a feed source. In its original form, Brassica seed, known as rapeseed, was harmful to humans due to its relatively high level of erucic acid in the oil and high level of glucosinolates in the meal. Erucic acid is commonly present in native cultivars in concentrations of 30 to 50 percent by weight based upon the total fatty acid content. Glucosinolates are undesirable in Brassica seeds since they can lead to the production of anti-nutritional breakdown products upon enzymatic cleavage during oil extraction and digestion. The erucic acid problem was overcome when plant scientists identified a germplasm source of low erucic acid rapeseed oil. More recently, plant scientists have focused their efforts on reducing the total glucosinolate content to levels less than 20 μmol/gram of whole seeds at 8.5% moisture.

Particularly attractive to plant scientists were so-called “double-low” varieties: those varieties low in erucic acid in the oil and low in glucosinolates in the solid meal remaining after oil extraction (i.e., an erucic acid content of less than 2 percent by weight based upon the total fatty acid content, and a glucosinolate content of less than 30 μmol/gram of the oil-free meal). These higher quality forms of rape, first developed in Canada, are known as canola. In addition, plant scientists have improved the fatty acid profile for rapeseed oil.

Numerous Sorghum species are used for food (as grain and in sorghum syrup or “sorghum molasses”), fodder, the production of alcoholic beverages, as well as for biofuels. Sorghum is a genus of about 20 species of grasses native to tropical and subtropical regions of Eastern Africa, with one species native to Mexico. Sorghum is cultivated in Southern Europe,

Central and North America and Southern Asia. Sorghum is also known as Duna, Egyptian Millet, Feterita, Guinea Corn, Jowar, Juwar, Kaffircorn, Milo and Shallu. Specifically, sorghum species include Sorghum almum, Sorghum amplum, Sorghum angustum, Sorghum arundinaceum, Sorghum bicolor (primary cultivated species, which includes many varieties and hybrids), Sorghum brachypodum, Sorghum bulbosum, Sorghum burmahicum, Sorghum controversum, Sorghum drummondii, Sorghum ecarinatum, Sorghum exstans, Sorghum grande, Sorghum halepense, Sorghum interjectum, Sorghum intrans, Sorghum laxiflorum, Sorghum leiocladum, Sorghum macrospermum, Sorghum matarankense, Sorghum miliaceum, Sorghum nigrum, Sorghum nitidum, Sorghum plumosum, Sorghum propinquum, Sorghum purpureosericeum, Sorghum stipoideum, Sorghum timorense, Sorghum trichocladum, Sorghum versicolor, Sorghum virgatum, Sorghum vulgare.

Worldwide, sorghum is a food grain for humans. In the United States, sorghum is used primarily as a feed grain for livestock. The feed value of grain sorghum is similar to that of corn. Grain sorghum has more protein and fat than corn, but is lower in vitamin A. When compared with corn on a per pound basis, grain sorghum feeding value ranges from 90% to nearly equal to corn. The grain is highly palatable to livestock, and intake seldom limits livestock productivity. The grain is fed to cattle, poultry, swine and sheep, primarily. However, some sorghum varieties and hybrids which were developed to deter birds are less palatable due to tannins and phenolic compounds in the seed. The grain of these less palatable varieties should be cracked or rolled before feeding to cattle, which improves the portion digested.

Grain sorghum is a grass similar to corn in vegetative appearance, but sorghum has more tillers and more finely branched roots than corn. Growth and development of sorghum is similar to corn, and other cereals. Sorghum seedlings are smaller than corn due to smaller seed size. Before the 1940s, most grain sorghums were 5-7 feet tall, which created harvesting problems. Today, sorghums have either two or three dwarfing genes in them, and are 2-4 feet tall. While there are several grain sorghum groups, most current grain sorghum hybrids have been developed by crossing Milo with Kafir. Other groups include Hegari, Feterita, Durra, Shallu, and Kaoliang. Many taller-stemmed varieties are grown in other countries. Taller-stemmed varieties are being developed in the United States and throughout the world for use as a feedstock for bio-fuel generation from biomass or juice. Sorghum-based feedstocks include juice from sweet sorghum, cellulosic biomass, and stover following harvest of grain sorghum.

The grain sorghum head is a panicle, with spikelets in pairs. Sorghums are normally self-fertilized, but can cross pollinate. Hybrid sorghum seed is produced utilizing cytoplasmic male sterility. Sorghum flowers begin to open and pollinate soon after the panicle has completely emerged from the boot. Pollen shedding begins at the top of the panicle and progresses downward for 6-9 days. Pollination normally occurs between 2:00 and 8:00 a.m., and fertilization takes place 6-12 hours later. Sorghum can branch from upper stalk nodes. If drought and heat damage the main panicle, branches can bear panicles and produce grain. The grain is free-threshing, as the lemma and palea are removed during combining The seed color is variable with yellow, white, brown, and mixed classes in the grain standards. Brown-seeded types are high in tannins, which lower palatability. Percentages of the seed components, endosperm (82%), embryo (12%), and seed coat (5-6%) are similar to corn.

A continuing goal of plant breeding is to develop stable, high yielding hybrids or varieties that are agronomically sound. The reasons for this goal are obvious—to maximize the amount of grain produced on the land and to supply food for both animals and humans.

The overall goal of a plant breeder is to combine, in a single variety/hybrid, various desirable traits of the parental lines. For field crops, these traits may include resistance to diseases and insects, tolerance to heat and drought, reducing time to crop maturity, greater yield, and better agronomic qualities. The mechanical harvesting of many crops has placed increased importance on the uniformity of plant characteristics such as germination, stand establishment, growth rate to maturity, and fruit size.

In order to have the plants stand tall and withstand the various mechanical forces applied by wind, rain, harvesting equipment, etc., it is important that the plant stalk/stem have good mechanical properties and that the roots are firmly anchored into the soil. Otherwise, the stalks/stems may bend, break or be pulled out, leading to yield losses.

It has become common place for plant breeders to use a set of fairly standard definitions for characterization of the mechanical properties of roots and stalks/stems. For example, brittle stalks/stems (brittle snap) (early) is a measure of the stalk/stem breakage due to high winds when the plant's growing point is just emerging from the soil line, while brittle stalks/stems (brittle snap) (late) is a measure of the stalk/stem breakage due to high winds closer to the time of harvest. Data are presented as percentage of plants that did not snap after a wind event.

Stalk/stem lodging, is a trait measured near harvest time, and is scored as the percentage of plants that do not exhibit stalk/stem breakage or crimpage at the base of the plant, when measured either by observation of natural lodging in the field, or by physically pushing on stalks/stems, and then determining the percentage of plants that break or do not break at the base of the plant. Stalk/stem lodging often is reported as a rating of one to nine where a higher score indicates less stalk/stem lodging potential (one is very poor, five is intermediate, and nine is very good, respectively, for resistance to stalk/stem lodging).

Root lodging is scored as the percentage of plants in a plot or field that do not exhibit excess leaning of the plant from the normal vertical axis. Typically, plants that lean from the vertical axis at an approximately 30 degree angle or greater would be counted as lodged. Root lodging often is reported as a rating of one to nine where a higher score indicates less root lodging potential (one is very poor, five is intermediate, and nine is very good, respectively, for resistance to root lodging). There are two types of root lodging, early root lodging and late root lodging. Early root lodging occurs right before flowering. Late root lodging occurs within approximately two weeks of anticipated harvest or after pollination. Late root lodging is more problematic because of the inability of the plant to recover before harvest, which results in consequent yield losses.

Both early and late root lodging occur as a result of the interaction between the root system, the soil and the wind force pushing the plants during a storm. In moisture saturated soils, frictional forces between the root system and the soil particles are significantly reduced allowing the root to rotate when a lateral force is applied to the stalks/stems. This rotation is in the direction of the force vector after the consequent lodging.

An embodiment of the present invention provides a method and means of objectively measuring the susceptibility of plants to root lodging, stalk or stem lodging, and brittle snap (broken stems or stalks).

A further embodiment of the present invention provides a device which objectively measures a plants' susceptibility to root lodging, stalk or stem lodging, and brittle snap (broken stems or stalks) that is inexpensive, easy to make and easy to use. An embodiment of the present invention provides a method and device that can be used to test more effectively a hybrid's or variety's susceptibility to root lodging, stalk or stem lodging, and brittle snap (broken stems or stalks) earlier in the product development cycle of a new hybrid or variety than existing standard methods. Moving the testing for these traits much earlier in the development cycle allows for selection and advancement of the more desirable lines more easily, and at a point in the process when seeds of a new hybrid or variety are relatively limited in numbers, which poses constraints with traditional methods that typically require more plants per hybrid or variety for evaluation of root lodging, stalk or stem lodging, and brittle snap (broken stems or stalks). These embodiments as well as numerous benefits of the present invention will become apparent from the detailed description of the invention which follows hereinafter.

### BRIEF SUMMARY OF THE INVENTION

A device to identify the susceptibility of plants to root lodging, stalk or stem lodging, and brittle snap (broken stems or stalks) is provided. The device is used to push on a plant stalk/stem and the force used to push on the stalk/stem, and the vibration of the stalk/stem during the test is recorded. As material breaks within the root mass or stalk/stem, an accelerometer measures stalk/stem vibration in response to the breaking events; the data is recorded to allow meaningful measurements and analysis of susceptibility of plant roots and/or stalks/stems to breakage. This allows for screening of various hybrids or varieties for their susceptibility to root lodging, stalk or stem lodging, and brittle snap (broken stems or stalks).

### BRIEF DESCRIPTION OF THE DRAWINGS

FIG. 1 is a schematic of the test setup, including the data acquisition system.

FIG. 2 is a perspective view of the components of the invention as applied to the lower portion of a plant ready for measurements.

FIG. 3 is a perspective view of an additional embodiment of the invention.

FIG. 4 is a perspective view of the embodiment of FIG. 3 in an engaged position.

FIG. 5 is a side view of the embodiment of FIG. 3.

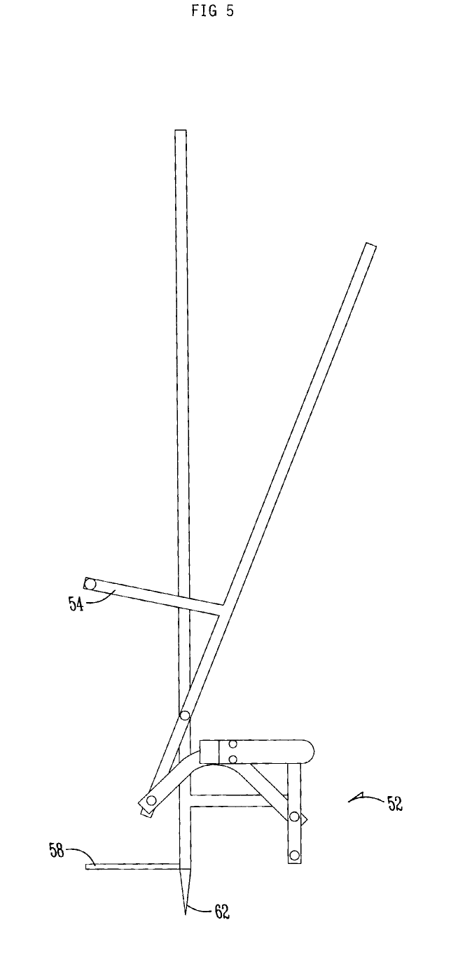

### DETAILED DESCRIPTION OF THE PREFERRED EMBODIMENTS

The device is used to measure the susceptibility of plants to root lodging, stalk or stem lodging, and brittle snap (broken stems or stalks). In particular, when examining root lodging the device is used to push on a plant stalk/stem, the force applied on the stalk/stem and the vibration of the stalk/stem due to root breakage during the test is recorded. Roots that are compromised in anchoring the plants break as a consequence of the applied lateral force. When examining stalk or stem lodging the device is used to push on a plant stalk/stem, the force applied on the stalk/stem and the vibration of the stalk/stem due to stalk or stem breakage during the test is recorded. Similarly, when examining brittle snap (broken stems or stalks) the device is used to push on a plant stalk/stem, the force applied on the stalk/stem and the vibration of the stalk/stem due to brittle snap (broken stems or stalks) during the test is recorded.

These breakage events are measured by an accelerometer, which measures stalk vibration. A software program (using Matlab, available from The Mathworks, Inc., Natick, MA) was written to correlate the number of breakage events in the accelerometer response and the input force to the known strength of the hybrid or variety. It is within the skill of the art to determine the appropriate threshold of signal to noise ratio for optimal use of the device. The device can be used in early hybrid or variety development to test for susceptibility to root lodging, stalk or stem lodging, and brittle snap (broken stems or stalks), before a large number of seeds are available for broad field testing, thus moving the opportunity for testing for these traits earlier in the development cycle of a new product.

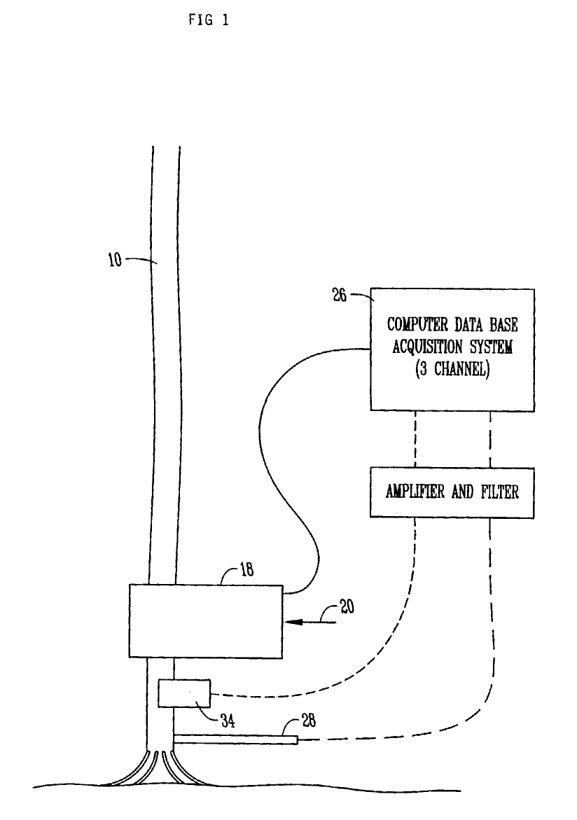

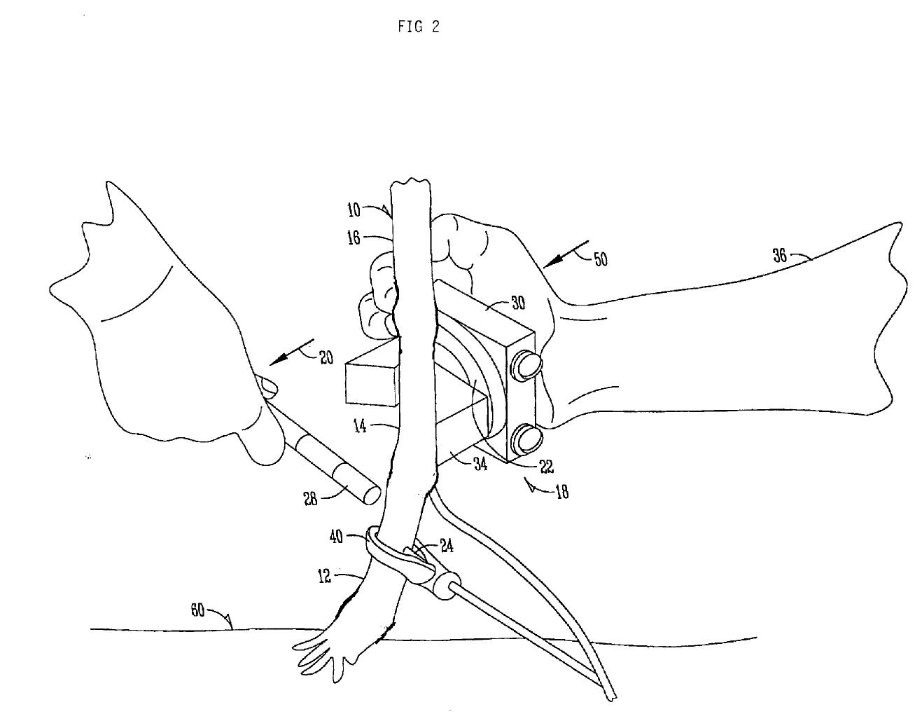

FIG. 1 is a schematic of the test setup, including the data acquisition system. A plant stalk/stem is illustrated in FIG. 2 at 10. The applied test force 50 from the test device 18 is applied along the directional arrow 20 (manually as explained below), and an associated force transducer 22 records this applied force 50. The applied force 50 is preferably applied at approximately 1 cm to 65 cms above the ground 60 depending upon the subject plant and test for root lodging, stalk or stem lodging, and brittle snap (broken stems or stalks). In particular, when measuring root lodging and stem lodging in canola the applied force 50 is preferably applied at approximately 15.2 cms to 61 cms, and most preferably at approximately 28 cms to 32 cms above the ground 60. When measuring brittle snap (broken stem) in canola he applied force 50 is preferably applied at approximately 30.5 cms to 61 cms above the ground 60. When measuring root lodging and stalk lodging in sorghum the applied force 50 is preferably applied at approximately 1.5 cms to 6.5 cms, and most preferably at approximately at 2.5 cms to 5.1 cms above the ground 60. When measuring root lodging and stalk lodging in sunflower the applied force 50 is preferably applied approximately at or about the lower one to two internodes above the ground 60. When measuring brittle snap (broken stalk) in sunflower the applied force 50 is preferably applied approximately at or about the lower two to three internodes above the ground 60.

An accelerometer 24 is attached to the plant, as illustrated in FIG. 2, preferably at approximately 1 cm to 65 cms above the ground 60 and records the stalk vibrations as the root lodging, stalk or stem lodging, and brittle snap (broken stems or stalks) occurs depending on the subject plant and the test for root lodging, stalk or stem lodging, and brittle snap (broken stems or stalks). Preferably, accelerometer 24 is placed close to the location of the applied force 50 as described above. The information is then stored in a computer 26 (see FIG. 1). A microphone 28 may be used to amplify the sound which can also be stored for later analysis if desired. The microphone aspect is, however, optional, since it also picks up background noise.

Turning from the schematic of FIG. 1 to the actual device 18, as shown in FIG. 2, it should first be mentioned that initial tests were run to determine what sort of device should be used to provide consistent results. It was determined that a device designed to measure the force used to generate root lodging, stalk or stem lodging, and brittle snap (broken stems or stalks), and the sound and stalk vibrations generated during the root lodging, stalk or stem lodging, and brittle snap (broken stems or stalks) event would provide the desired consistent results. This measurement allows for reproducible early testing of hybrids or varieties. It was during this investigative process that it was discovered that accurate data was obtained with a handheld device, versus one that uses a mechanical drive and motor to push on the plant stalk/stem. A device with a mechanical drive and motor to push on the plant stalks/stems has its own mechanical vibrations and audible noise, both of which can interfere with obtaining accurate counts and generating consistent data. Thus an important feature for the present invention is that it is a handheld device using manual pushing against a backing plate 30 to apply force to a plant stalk/stem, leading to a root lodging, stalk or stem lodging, and brittle snap (broken stems or stalks) event.

The backing plate 30 can be made from a variety of materials, including but not limited to, metals, plastics, Teflon®, nylon and wood. Specifically, an aluminum backing plate 30 is satisfactory. Force transducer 22 is mounted to the backing plate 30 so that the force 50 applied on the transducer 22 is measured. Stalk/stem holder 34, is a plate with a V-notch in its front, and which can also be made from numerous materials as described above, is mounted, for example, with a screw to the center mounting plate of the force transducer 22. The notch portion of the V-notch of stalk/stem holder 34 is applied against the longitudinal axis of the plant stalk/stem to allow the force 50 to be applied perpendicular to the stalk/stem. In this way, the user is assured force 50 is applied at the correct location. Other suitable notch shapes may be used in the present invention such as a U-notch or any variation that enables the stalk/stem to be held in place while the test is run.

The force transducer 22 can be, but does not necessarily have to be a Loadstar AS-C-50-025 load sensor, available from Loadstar Sensors, Inc., Fremont, Calif. It is within the skill in the art to determine the suitability of other readily available force transducers. As illustrated in FIG. 2, backing plate 30, force transducer 22 and stalk/stem holder 34 are placed at approximately 1 to 65 centimeters above the ground 60 depending on the test, i.e., root lodging, stalk or stem lodging, or brittle snap (broken stems or stalks) measurements being taken, and then force 50 is applied as a human operator 36 pushes against the stalk/stem 10.

The accelerometer 24 (one suitable example is PCB 35 2A60, available from PCB Piezotronics, Depew, NY) is then positioned adjacent to the plant stalk/stem 10 at its lower end, at approximately 1 to 65 centimeters above the ground 60 as previously described. As illustrated in FIG. 2, accelerometer 24 is affixed into the operative position by any suitable means. As illustrated here, accelerometer 24 is mounted using a velcro strip 40 circling the stalk/stem 10 at approximately 1 to 65 centimeters above the ground 60. The velcro strip 40 is then attached to the accelerometer 24 to hold the accelerometer 24 against the stalk/stem 10. Alternatively, the accelerometer 24 may be attached to the stalk/stem 10 by any suitable means including but not limited to pins or spikes (not shown) inserted into the stalk/stem 10. In this way, the vibration is sensed by the accelerometer 24 as the pushing force 50 causes mechanical breakage of the plant's roots or stalk/stem. The pins or spikes may be made of any suitable material so long as the accelerometer 24 is held against the stalk 10 such that the vibration is sensed by the accelerometer 24 as the pushing force 50 causes mechanical breakage of the plant's roots or stalk/stem.

As illustrated, microphone 28 may be held near to the ground 60 at the base of the stalk/stem 10 in order to record the sound of the breaking events. However, the sound captured from the breaking events, as opposed to the vibrations, has been found to be a less reliable predictor since the former is subject to also capturing background noise from a variety of other sources in the vicinity.

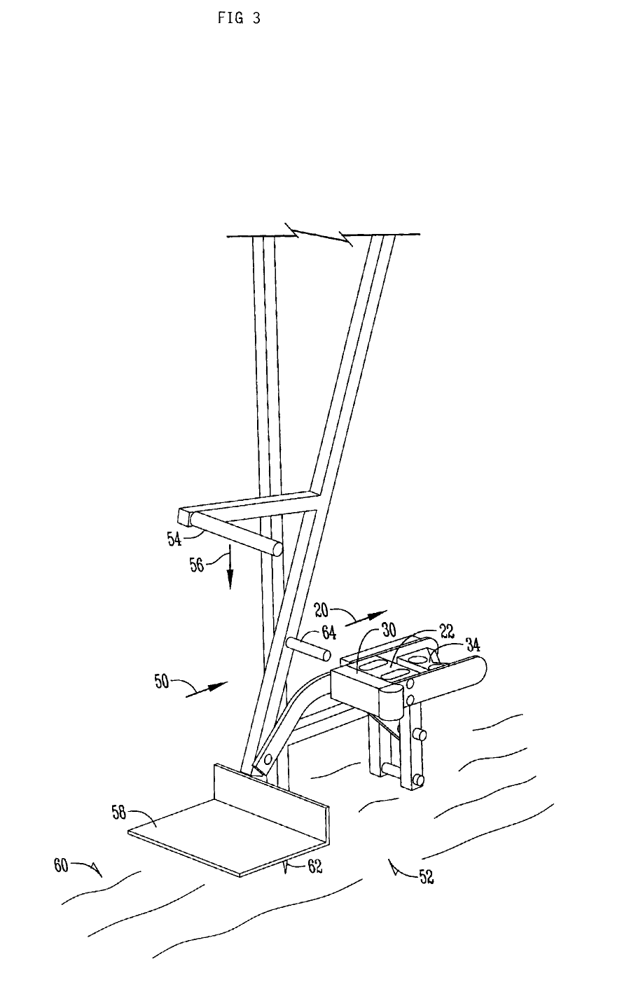

A further embodiment of the present invention is shown in FIG. 3. The applied test force 50 from the test device 52 is applied along the directional arrow 20, wherein an operator (not shown) places a foot on bar 54 and pushes down along directional arrow 56 along pivot point 64, and an associated force transducer 22 records this applied force 50. Pivot point 64 may also be a cam mechanism (not shown). Plate 58 of test device 52 is anchored to the ground 60 by spike 62. Plate 58 can be made from a variety of materials, including but not limited to, metals, plastics, Teflon®, nylon and wood. Specifically, an aluminum plate 58 is satisfactory. Spike 62 may be made from a variety of materials, including but not limited to, metals, plastics, Teflon®, nylon and wood. Specifically, an aluminum spike 62 is satisfactory. Spike 62 is securely fastened to the ground 60 to prevent movement of plate 58 of test device 52.

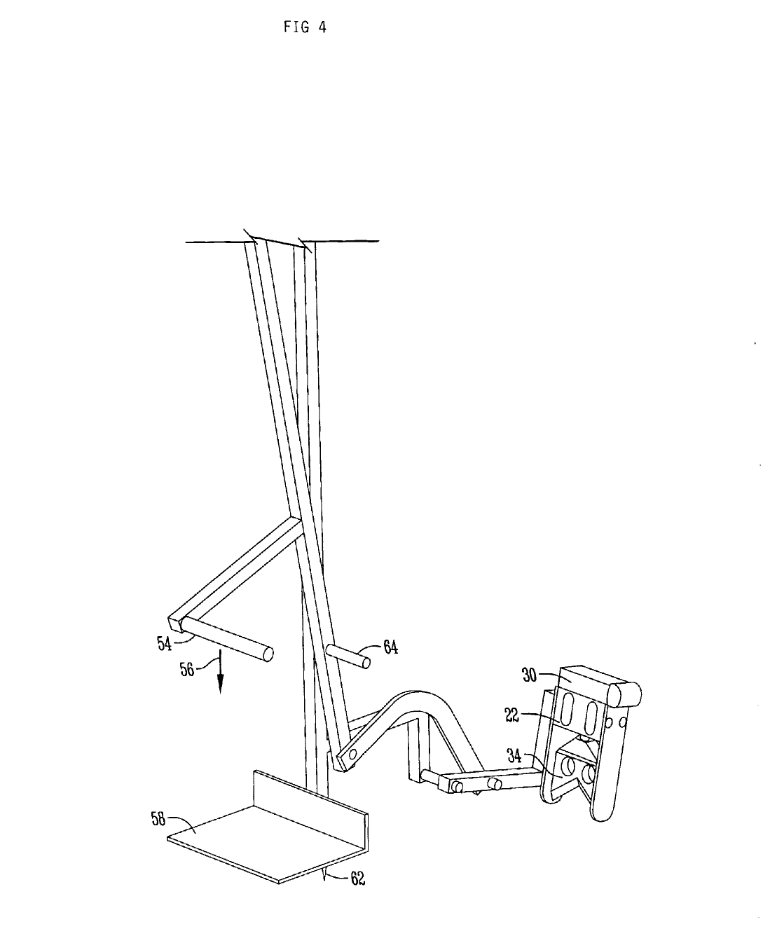

An accelerometer 24 is attached to the plant, as illustrated in FIG. 2, and as previously described. The backing plate 30 can be made from a variety of materials, including but not limited to, metals, plastics, Teflon®, nylon and wood. Specifically, an aluminum backing plate 30 is satisfactory. Force transducer 22 is mounted to the backing plate 30 so that the force 50 applied on the transducer 22 is measured. Stalk/stem holder 34, is a plate with a V-notch in its front, and which can also be made from numerous materials as described above, is mounted, for example, with a screw to the center mounting plate of the force transducer 22. The notch portion of the V-notch of stalk/stem holder 34 is applied against the longitudinal axis of the plant's stalk/stem to allow the force 50 to be applied perpendicular to the stalk/stem. In this way, the user is assured force 50 is applied at the correct location. This is illustrated more fully in FIG. 4. Other suitable notch shapes may be used in the present invention such as a U-notch or any variation that enables the stalk/stem to be held in place while the test is run.

The devices described herein can be used to push on individual plants to simulate root lodging, stalk or stem lodging, or brittle snap (broken stems or stalks). During the push, the force, the stalk/stem vibration and the sound (optional) are measured. As illustrated in the schematic of FIG. 1, all are measured as time signals recorded into a personal computer based multi-channel data acquisition system. The signals are sampled at approximately 30,000 Hz with 200,000 data points collected for each plant. The long sampling time is used to ensure that the complete root lodging, stalk or stem lodging, or brittle snap (broken stems or stalks) event is captured.

The accelerometer and the microphone signals are amplified and passed through an anti-aliasing filter with a 15,000 Hz cutoff frequency. The force transducer signal is input directly to the data acquisition system.

While the embodiments described above use a pushing force it is within the skill in the art to modify the apparatus to use a pulling force on a plant stalk/stem. The pulling force applied to the stalk/stem and the vibration of the stalk/stem due to root lodging, stalk or stem lodging, or brittle snap (broken stems or stalks) during the test is recorded as described above. During field testing, the data acquisition system is located at the edge of the field and 150 foot long cables are used to connect the computer based data acquisition system with the power supply of the microphone, accelerometer and the force transducer. It should be noted that each device is located within approximately 3-5 feet of its power supply. The cable lengths should be limited such that they do not produce any discernable loss in measuring signals. All electronic devices in the field testing are powered by a portable gas powered generator.

### EXAMPLES

The following examples are illustrative and not limiting. One of skill will recognize a variety of non-critical parameters that can be altered to achieve essentially similar results.

### Example 1 Canola Testing

A field experiment with a three-level design with three variables is performed: a) hybrid (weak or strong roots), b) soil moisture (irrigated or dry), and c) stage of development (early or late). The tests are blocked relative to each variable and a total of at least 20 plants are tested for each configuration. In preparing plants for attachment of the device the plants may optionally be topped (cut-off) thereby reducing background noise.

Three Pioneer hybrids are assessed, one with known high scores for root lodging, stalk or stem lodging, and brittle snap (broken stems or stalks), one with known low scores for root lodging, stalk or stem lodging, or brittle snap (broken stems or stalks) and one test hybrid. For root lodging testing, irrigation is performed with a drip tape for 18 to 24 hours prior to data collection. The plants are tested during an early developmental stage and again at a late developmental stage closer to harvest.

The applied force measurements and count data are collected from the experiment and analyzed using a paired-wise Tukey analysis. The difference in the means is divided by the standard error value, the result is rounded down and then one is added to this number. This gives an estimate of the number of bins that could be used to separate different hybrids from the data of each test. Thus, if the standard error is the same as the difference of the mean then the ratio will be one and adding one to this number gives two as the number of distinct categories or bins that hybrids could be separated into. The Tukey analysis for the event counts is applied separately to the early and late data. The P values are determined and significant differences enable distinguishing between the strong and weak hybrids, for subsequent selection and advancement.

### Example 2 Sunflower Testing

A field experiment with a three-level design with three variables is performed: a) hybrid (weak or strong roots), b) soil moisture (irrigated or dry), and c) stage of development (early or late). The tests are blocked relative to each variable and a total of at least 20 plants are tested for each configuration. In preparing plants for attachment of the device the plants may optionally be topped (cut-off) thereby reducing background noise.

Three Pioneer hybrids are assessed, one with known high scores for root lodging, stalk or stem lodging, and brittle snap (broken stems or stalks), one with known low scores for root lodging, stalk or stem lodging, or brittle snap (broken stems or stalks) and one test hybrid. For root lodging testing, irrigation is performed with a drip tape for 18 to 24 hours prior to data collection. The plants are tested during an early developmental stage and again at a late developmental stage closer to harvest.

The applied force measurements and count data are collected from the experiment and analyzed using a paired-wise Tukey analysis. The difference in the means is divided by the standard error value, the result is rounded down and then one is added to this number. This gives an estimate of the number of bins that could be used to separate different hybrids from the data of each test. Thus, if the standard error is the same as the difference of the mean then the ratio will be one and adding one to this number gives two as the number of distinct categories or bins that hybrids could be separated into. The Tukey analysis for the event counts is applied separately to the early and late data. The P values are determined and significant differences enable distinguishing between the strong and weak hybrids, for subsequent selection and advancement.

### Example 3 Sorghum Testing

A field experiment with a three-level design with three variables is performed: a) hybrid (weak or strong roots), b) soil moisture (irrigated or dry), and c) stage of development (early or late). The tests are blocked relative to each variable and a total of at least 20 plants are tested for each configuration. In preparing plants for attachment of the device the plants may optionally be topped (cut-off) thereby reducing background noise.

Three Pioneer hybrids are assessed, one with known high scores for root lodging, stalk or stem lodging, and brittle snap (broken stems or stalks), one with known low scores for root lodging, stalk or stem lodging, or brittle snap (broken stems or stalks) and one test hybrid. For root lodging testing, irrigation is performed with a drip tape for 18 to 24 hours prior to data collection. The plants are tested during an early developmental stage and again at a late developmental stage closer to harvest.

The applied force measurements and count data are collected from the experiment and analyzed using a paired-wise Tukey analysis. The difference in the means is divided by the standard error value, the result is rounded down and then one is added to this number. This gives an estimate of the number of bins that could be used to separate different hybrids from the data of each test. Thus, if the standard error is the same as the difference of the mean then the ratio will be one and adding one to this number gives two as the number of distinct categories or bins that hybrids could be separated into. The Tukey analysis for the event counts is applied separately to the early and late data. The P values are determined and significant differences enable distinguishing between the strong and weak hybrids, for subsequent selection and advancement.

From this information it can be seen that a unique handheld device reliable in predicting important mechanical properties of plants has been designed and developed which enables the collection of meaningful and important data to facilitate plant breeding and product development processes. All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims. Thus, many modifications and other embodiments of the inventions set forth herein will come to mind to one skilled in the art to which these inventions pertain having the benefit of the teachings presented in the foregoing descriptions and the associated drawings. For example, though examples are presented herein, one skilled in the art will appreciate that the data may be analyzed in many different manners consistent with the parameters of the study being investigated. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. The following examples are offered to further illustrate but not limit both the system and/or device and/or method.

What is claimed is:

1. A device for measuring sorghum plant susceptibility to root lodging, comprising:
a stalk holder to apply force to a sorghum stalk;
a transducer operably linked to the stalk holder to output a voltage signal related to force applied by the stalk holder;
an accelerometer for attachment to a sorghum stalk for measuring stalk vibrations as the stalk holder applies force to a stalk; and
a recorder for recording the voltage output signal of said transducer and the vibration output signal of said accelerometer operably linked to each of said transducer and said accelerometer.

2. The device of claim 1 which is portable.

3. A method of measuring sorghum plant susceptibility to root lodging, said plant having a root portion and a stalk portion, comprising:
applying a pushing force to the lower portion of a sorghum stalk to push the sorghum stalk over;
measuring the applied pushing force required to push the stalk over;
measuring the vibrations in the lower portion of the stalk caused by root breakage; and
determining the sorghum plant's root lodging properties from the measured pushing force and vibrations caused by root breakage.

4. The method of claim 3 wherein the pushing force to the lower portion of the sorghum stalk is measured in the region of the stalk from approximately 1.5 cms to 6.5 cms above the ground.

5. The method of claim 3 wherein the vibrations in the lower portion of the stalk are measured above the roots and approximately 3.0 cms above the ground.

6. A device for measuring sorghum plant susceptibility to stalk lodging, comprising:
a stalk holder to apply force to a sorghum stalk;
a transducer operably linked to the stalk holder to output a voltage signal related to force applied by the stalk holder;
an accelerometer for attachment to a sorghum stalk for measuring stalk vibrations as the stalk holder applies force to a stalk; and
a recorder for recording the voltage output signal of said transducer and the vibration output signal of said accelerometer operably linked to each of said transducer and said accelerometer.

7. The device of claim 6 which is portable.

8. A method of measuring sorghum plant susceptibility to stalk lodging, said plant having a root portion and a stalk portion, comprising:
applying a pushing force to the lower portion of a sorghum stalk to push the sorghum stalk over;
measuring the applied pushing force required to push the stalk over;
measuring the vibrations in the lower portion of the stalk caused by stalk breakage; and
determining the sorghum plant's stalk lodging properties from the measured pushing force and vibrations caused by stalk breakage.

9. The method of claim 8 wherein the pushing force to the lower portion of the sorghum stalk is measured in the region of the stalk from approximately 1.5 cms to 6.5 cms above the ground.

10. The method of claim 8 wherein the vibrations in the lower portion of the stalk are measured above the roots and approximately 3.0 cms above the ground.

11. A device for measuring canola plant susceptibility to root lodging, comprising: a stem holder to apply force to a canola stem;
a transducer operably linked to the stem holder to output a voltage signal related to force applied by the stem holder;
an accelerometer for attachment to a canola stem for measuring stem vibrations as the stem holder applies force to a stem; and
a recorder for recording the voltage output signal of said transducer and the vibration output signal of said accelerometer operably linked to each of said transducer and said accelerometer.

12. The device of claim 11 which is portable.

13. A method of measuring canola plant susceptibility to root lodging, said plant having a root portion and a stem portion, comprising:
applying a pushing force to the lower portion of a canola stem to push the canola stem over;
measuring the applied pushing force required to push the stem over;
measuring the vibrations in the lower portion of the stem caused by root breakage; and
determining the canola plant's root lodging properties from the measured pushing force and vibrations caused by root breakage.

14. The method of claim 13 wherein the pushing force to the lower portion of the canola stem is measured in the region of the stem from approximately 15.2 cms to 61 cms above the ground.

15. The method of claim 13 wherein the vibrations in the lower portion of the stem are measured above the roots and approximately 30 cms above the ground.

16. A device for measuring canola plant susceptibility to stem lodging, comprising:
a stem holder to apply force to a canola stem;
a transducer operably linked to the stem holder to output a voltage signal related to force applied by the stem holder;
an accelerometer for attachment to a canola stem for measuring stem vibrations as the stem holder applies force to a stem; and
a recorder for recording the voltage output signal of said transducer and the vibration output signal of said accelerometer operably linked to each of said transducer and said accelerometer.

17. The device of claim 16 which is portable.

18. A method of measuring canola plant susceptibility to stem lodging, said plant having a root portion and a stem portion, comprising:
applying a pushing force to the lower portion of a canola stem to push the canola stem over;
measuring the applied pushing force required to push the stem over;
measuring the vibrations in the lower portion of the stem caused by stem breakage; and
determining the canola plant's stem lodging properties from the measured pushing force and vibrations caused by stem breakage.

19. The method of claim 18 wherein the pushing force to the lower portion of the canola stem is measured in the region of the stem from approximately 15.2 cms to 61 cms above the ground.

20. The method of claim 18 wherein the vibrations in the lower portion of the stem are measured above the roots and approximately 30 cms above the ground.

21. A device for measuring canola plant susceptibility to brittle snap, comprising:
a stem holder to apply force to a canola stem;
a transducer operably linked to the stem holder to output a voltage signal related to force applied by the stem holder;
an accelerometer for attachment to a canola stem for measuring stem vibrations as the stem holder applies force to a stem; and
a recorder for recording the voltage output signal of said transducer and the vibration output signal of said accelerometer operably linked to each of said transducer and said accelerometer.

22. The device of claim 21 which is portable.

23. A method of measuring canola plant susceptibility to brittle snap, said plant having a root portion and a stem portion, comprising:
applying a pushing force to the lower portion of a canola stem to snap the canola stem over;
measuring the applied pushing force required to snap the stem over;
measuring the vibrations in the lower portion of the stem caused by stem breakage; and
determining the canola plant's brittle snap properties from the measured pushing force and vibrations caused by stem breakage.

24. The method of claim 23 wherein the pushing force to the lower portion of the canola stem is measured in the region of the stem from approximately 15.2 cms to 61 cms above the ground.

25. The method of claim 23 wherein the vibrations in the lower portion of the stem are measured above the roots and approximately 30 cms above the ground.

26. A device for measuring sunflower plant susceptibility to root lodging, comprising:
a stalk holder to apply force to a sunflower stalk;
a transducer operably linked to the stalk holder to output a voltage signal related to force applied by the stalk holder;
an accelerometer for attachment to a sunflower stalk for measuring stalk vibrations as the stalk holder applies force to a stalk; and
a recorder for recording the voltage output signal of said transducer and the vibration output signal of said accelerometer operably linked to each of said transducer and said accelerometer.

27. The device of claim 26 which is portable.

28. A method of measuring sunflower plant susceptibility to root lodging, said plant having a root portion and a stalk portion, comprising:
applying a pushing force to the lower portion of a sunflower stalk to push the sunflower stalk over;
measuring the applied pushing force required to push the stalk over;
measuring the vibrations in the lower portion of the stalk caused by root breakage; and
determining the sunflower plant's root lodging properties from the measured pushing force and vibrations caused by root breakage.

29. The method of claim 28 wherein the pushing force to the lower portion of the sunflower stalk is measured in the region spanning the stalk's second and third internodes.

30. The method of claim 28 wherein the vibrations in the lower portion of the stalk are measured above the roots and below the first node of the plant.

31. A device for measuring sunflower plant susceptibility to brittle snap, comprising:
a stalk holder to apply force to a sunflower stalk;
a transducer operably linked to the stalk holder to output a voltage signal related to force applied by the stalk holder;
an accelerometer for attachment to a sunflower stalk for measuring stalk vibrations as the stalk holder applies force to a stalk; and
a recorder for recording the voltage output signal of said transducer and the vibration output signal of said accelerometer operably linked to each of said transducer and said accelerometer.

32. The device of claim 31 which is portable.

33. A method of measuring sunflower plant susceptibility to brittle snap, said plant having a root portion and a stalk portion, comprising:
applying a pushing force to the lower portion of a sunflower stalk to snap the sunflower stalk over;
measuring the applied pushing force required to snap the stalk over;
measuring the vibrations in the lower portion of the stalk caused by stalk breakage; and
determining the sorghum plant's brittle snap properties from the measured pushing force and vibrations caused by stalk breakage.

34. The method of claim 33 wherein the pushing force to the lower portion of the sunflower stalk is measured in the region spanning the stalk's second and third internodes.

35. The method of claim 33 wherein the vibrations in the lower portion of the stalk are measured above the roots and below the first node of the plant.
